(19) United States
(12) Patent Application Publication
(10) Pub. No.: US 2016/0316957 A1
(43) Pub. Date: Nov. 3, 2016

(54) Apparatus and Method for making cold brewed beverage from unfiltered water

(71) Applicant: Minh Tran, Huntington Beach, CA (US)

(72) Inventor: Minh Tran, Huntington Beach, CA (US)

(73) Assignee: SAIGONX CORPORATION, Huntington Beach, CA (US)

(21) Appl. No.: 14/699,487

(22) Filed: Apr. 29, 2015

(51) Int. Cl. A47J 31/00; A47J 31/60; A23F 3/18; A23F 5/26; C02F 1/00; C02F 1/28

(52) U.S. Cl. CPC A47J 31/005; C02F 1/003; C02F 1/283; A23F 3/18; A23F 5/26; A47J 31/605; C02F 2307/02

(57) ABSTRACT

The invention is aimed at providing a method and apparatus to prepare cold brewed beverage from contaminated water. This invention is very useful for people engaged in outdoor activities like hiking, camping or backpacking who find it extremely difficult to either find a supply of potable water or carry pre-packaged beverages. This invention provides for simple means to prepare cold brewed beverage from any source of water “on the go”.

### BACKGROUND

1. Field of the Technology

The present invention relates to the fields of treatment of water using household-type filters for producing potable water, e.g. pitchers, bottles (C02F1/003), apparatus for making beverages (A47J31/06, A47J31/402), containers, packaging elements or packages specially adapted to allow liquid to pass through the contents (B65D85/8043), tea infusers (A47G19/16).

2. Description of the Prior Art

Infused beverage, such as tea have been consumed in United States for centuries. While infused hot beverages are very common, the demand for infused cold beverages, especially for cold brew coffee has been increasing in the recent years. Cold brew coffee is less acidic and less bitter than hot brew coffee and thus gaining increasing popularity among coffee lovers.

The cold brewing process involves steeping a mixture of coffee grounds and water for about 8-24 hours and then filtering the mixture to obtain either the extract or the coffee itself based on the proportion of water. But, this process requires a consumer to handle coffee beans and/or coffee grounds, which is messy and undesirable. For example, in some cases, consumers are required to measure dry coffee grounds (or coffee beans) during the initial steps of the cold brew process. Then, once the cold brew process is complete, consumers are required to dispose of loose, soaked coffee grounds (or coffee beans).

Thus, there is a need for a cold brew beverage system that is less messy and cumbersome and easy to use and that provides a compact and convenient solution to the consumer who wishes to enjoy the benefits and taste of cold brewed beverage.

Another shortcoming of existing cold brew beverage systems is that they are not portable and do not allow for the preparation of beverage “on the go”. For example, if a consumer is hiking or backpacking and wants to enjoy cold brew beverage, he or she either has to carry bottles of beverage prepared in advance or carry the cumbersome cold brew system. Since, the consumer performing outdoor adventure activities would likely want to avoid carrying the cumbersome cold brew system along, the consumer has to opt for a stale beverage. Furthermore, when a consumer is engaged in an outdoor adventure like hiking or backpacking, it is very likely that they do not have access to a clean supply of water. This makes the cold brew beverage making impossible even when the consumer is ready to carry the cumbersome cold brew system along.

Therefore it is desirable to develop an integrated water purifier and cold brew beverage system that is portable and simple to use and can utilize water from any source to yield a fresh cup of cold brewed beverage.

### BRIEF SUMMARY

The problem to be solved is to provide an apparatus and method to brew cold beverage from unfiltered water. The solution is achieved by an integrated water filter and cold brew beverage apparatus, which is portable and very simple to use.

The illustrated embodiment of the invention thus includes an apparatus for preparing cold brew beverage from unfiltered water using a charge of beverage brewing material comprising a first receptacle, a second receptacle with the second receptacle positioned below the first receptacle, a gravity fed water filter, a coupling which joins the first and second receptacles together, and a container including the charge of beverage brewing material disposed in the second receptacle.

The unfiltered water moves from the first receptacle through the purification filter into the second receptacle and enters the container containing the beverage brewing material to steep in the filtered water.

The apparatus further includes a timer mounted anywhere on or in the apparatus. The timer indicates to the user when the beverage is ready for consumption.

In one embodiment, the first and the second receptacles are in sizes convenient to be carried by hikers, backpackers and the like and the water purification filter is made up of ceramic material. The ceramic filter is helpful in filtering chemical and biological impurities from any water source, and provides for a means to obtain safe and clean water anywhere.

In another embodiment, the water purification filter is made up of carbon material. The carbon filter is more efficient in filtering tap water and provides for a means to obtain a quick supply of clean water when potable water is available.

In still another embodiment, the container including the charge of beverage brewing material is in a cubic shape. The cubic shape provides maximum exposure from water to coffee grounds by the design due to the high surface area to volume ratio while maintaining compactness structure to help fit inside the second receptacle.

The apparatus further includes a flashlight mounted anywhere on or in the apparatus. The flashlight serves a multipurpose use for the consumer during hiking, camping or power outages in the home.

The illustrated embodiments of the invention also include a method comprising the steps of providing a first receptacle for holding unfiltered water, providing a second receptacle such that the second receptacle is positioned below the first receptacle and is capable of holding beverage, providing a gravity fed water filter, providing a coupling which joins the first and second receptacles together, providing a container including the charge of beverage brewing material disposed in the second receptacle, adding unfiltered water to the first receptacle, attaching the first receptacle on top of the second receptacle using the couplings such that the unfiltered water from the first receptacle filters through the said filter and moves into the second receptacle and enters the container containing beverage brewing material thus allowing the filtered water and beverage brewing material to steep for a given amount of time producing a fresh cold brew beverage.

The method further includes the step of providing a timer mounted anywhere on or in the apparatus which indicates to the user when the beverage is ready for consumption.

Other objects, features, embodiments and advantages of the invention will be apparent from the following specification taken in conjunction with the following drawings.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a perspective view of a preferred embodiment of the invention where the first and second receptacles are in travel sized for “on the go” use.

FIG. 2 is a perspective view of another preferred embodiment of the invention where the first and second receptacles are in multiple serve sizes more compatible for home or office use.

FIG. 3 is a side perspective view of the filter assembly with the ring coupling.

FIG. 4 is a bottom perspective view of the filter assembly with the ring coupling.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

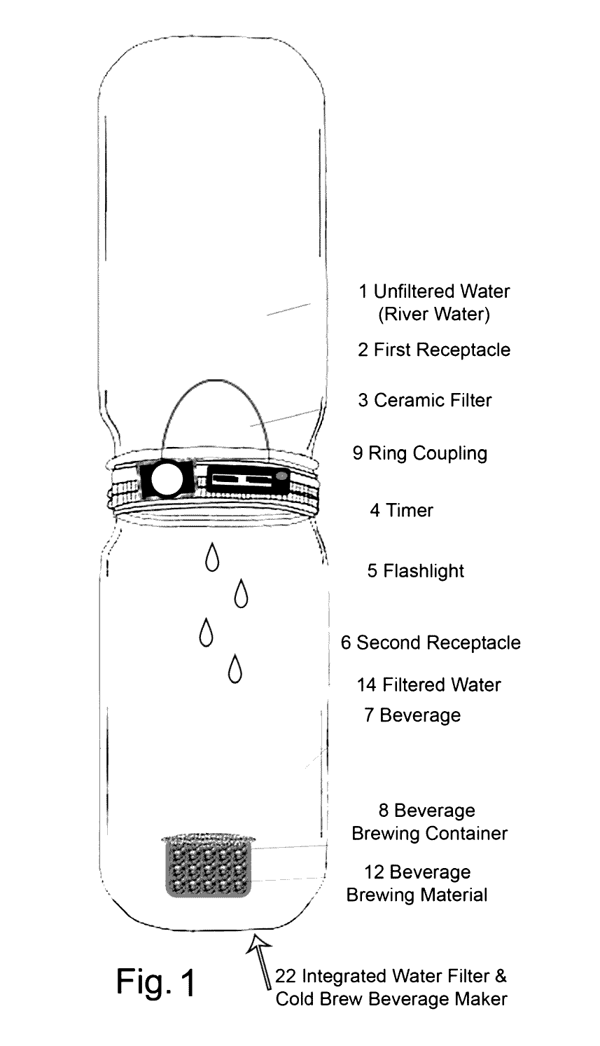

FIG. 1 is a perspective view of a preferred embodiment of the invention where the first and second receptacles 2, 6 are travel sized for “on the go” use. FIG. 1 shows first receptacle 2, second receptacle 6, the second receptacle 6 positioned below the first receptacle 2, a gravity fed ceramic or biological water filter 3, a ring coupling 9, which joins the first and second receptacles 2, 6 together and a container or bag 8 including the charge 12 of beverage brewing material disposed in the second receptacle 6. A timer 4 in the illustrated embodiment displays a progressive bar (not shown) indicating to the user when the beverage is ready for consumption. Also included is a flashlight 5 which can serve as a source of light during an emergency or camping. Contaminated water 1 is filtered into second receptacle 6 through gravity fed filter 3 and the beverage brewing bag 8 steeps in the filtered water 14 to yield cold brewed beverage 7.

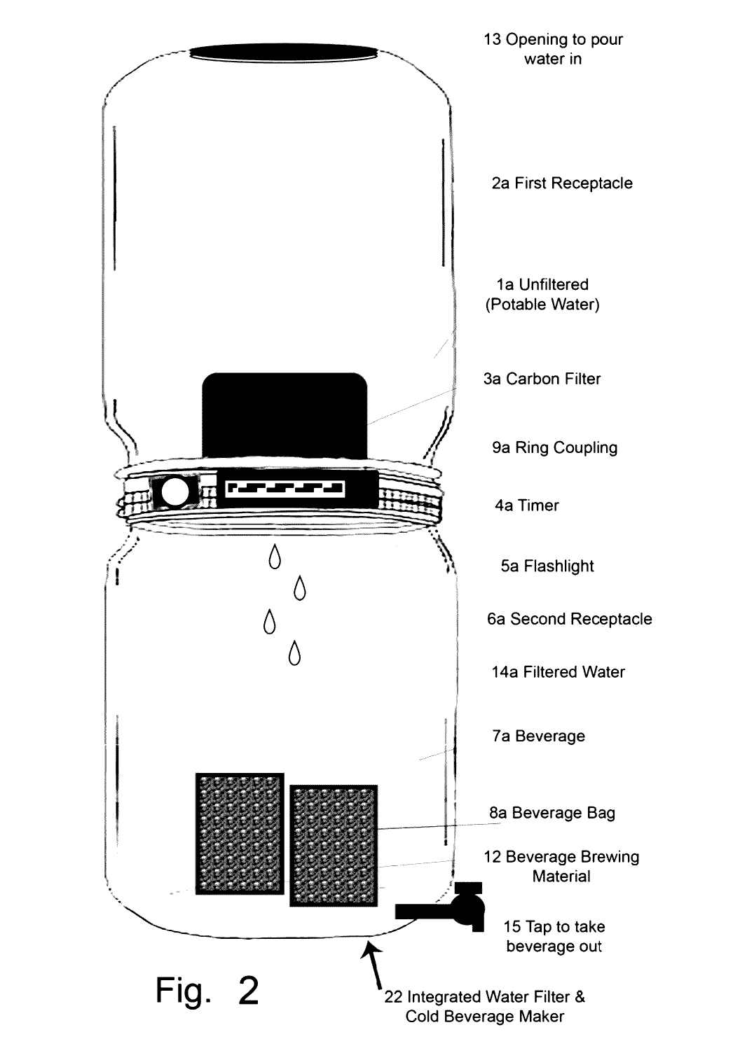

FIG. 2 is a perspective view of another embodiment of the invention where the first and second receptacles 2a, 6a are in multiple serving sizes more compatible for home or office use. Included in combination are a first receptacle 2a, second receptacle 6a, the second receptacle 6a being positioned below the first receptacle 2a, a gravity fed carbon water filter 3a, a ring coupling 9a, which joins the first and second receptacles 2a, 6a together and a container or bag 8a including the charge 12a of beverage brewing material disposed in the second receptacle 6a. A timer 4a displays a progressive bar (not shown) indicating to the user when the beverage is ready for consumption. Flashlight Sa serves as a source of light during emergency. Unfiltered, but potable water 1a is poured into the first receptacle 2a through the opening 13, filtered into second receptacle 6a through a charcoal filter 3a and steeped with beverage brewing bag or charge 12 a to yield cold brewed beverage. The tap 15 can be used to take the beverage out of the second receptacle 6a.

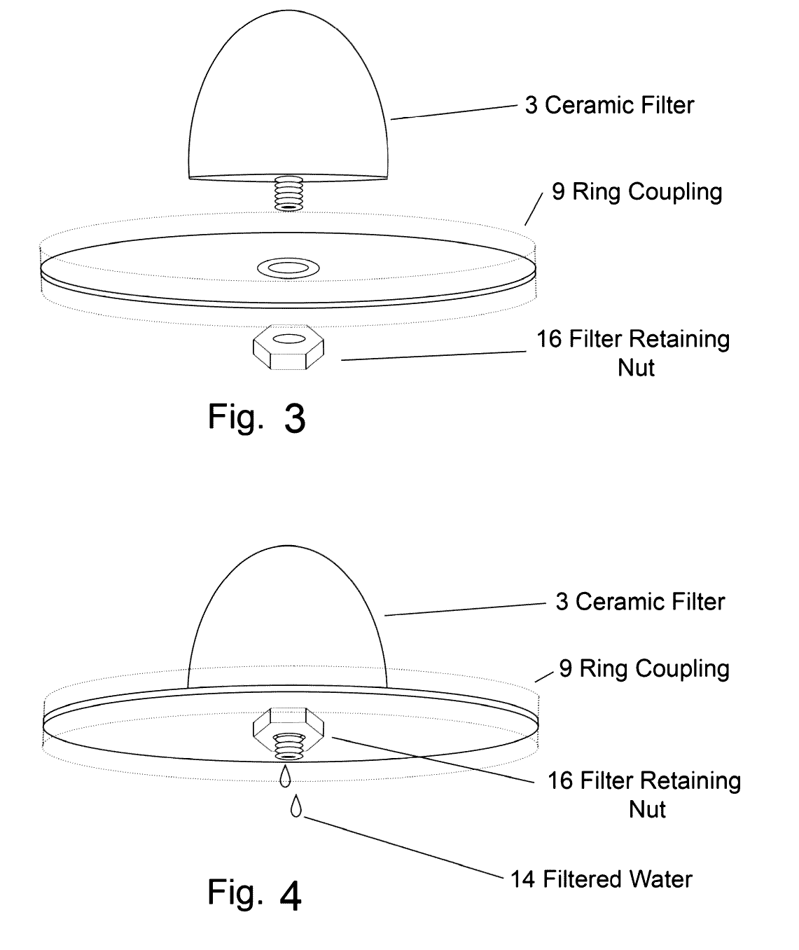

FIG. 3 is a side perspective view of one embodiment of the filter assembly with the ring coupling and FIG. 4. is a bottom perspective view of the same embodiment of the assembly which show how the filter 3 is fastened to the ring coupling 9 with the help of a filter retaining nut 16.

The preferred embodiment of this invention includes an integrated water filter and cold brew beverage maker, generally denoted by reference numeral, 22 using a charge 12 of beverage brewing material, such as tea or coffee, which includes a first receptacle 2, 2a for holding unfiltered water 1a or contaminated water 1 and a second receptacle 6, 6a for holding filtered water 14, 14a. The first and the second receptacles 2, 2a, 6 and 6a can be made up of metal or glass or plastic or a similar material. The receptacles 2, 2a, 6 and 6a are arranged with respect to each other such that the one 6, 6a containing filtered water 14, 14a is positioned below the one 2, 2a containing unfiltered water 1 or contaminated water 1 and are joined together by a coupling 9, 9a. The couplings 9, 9a can be rings with threading or clamps to fasten to both the receptacles 2 and 6, or 2a and 6a, at opposite ends or sides of coupling 9, 9a. The coupling also prevents the unfiltered water from spilling from the first receptacle 2, 2a into the second receptacle 6, 6a, receiving the filtered water. The coupling mechanism is threading, two sets of internal threads (not shown) for fastening the two receptacles 2 and 6, or 2a and 6a, or one set of extemal thread and one set of internal thread for fastening the two receptacles 2 and 6, or 2a and 6a together. The preferred embodiment further includes a gravity fed water filter 3, 3a placed between the two said receptacles 2 and 6, or 2a and 6a. In the illustrated embodiment the water flows through receptacles 2, 6, 2a and 6a due to gravity and air passes through the filter in the opposite direction.

However, it is within the scope of the invention that the assembly and the movement of water through it could be pressurized, particularly in the portable embodiment where the receptacles might be stored on their side during brewing or even in an inverted position. In such an embodiment, the upper receptacle 2, 2a, could be provided with an air hand pump or other pressure source used to keep the unfiltered water in receptacle 2, 2a under a greater pressure than the filtered water in receptacle 6, 6a. Thus, under the pressure gradient water would move from receptacle 2, 2a to receptacle 6, 6a regardless of the orientation of the receptacles 2, 2a, 6, 6a with respect to gravity.

The water filter 3, 3a can also be placed between the two receptacles 2 and 6, or 2a and 6a, in conjunction with the ring 9, 9a. For example, as shown in FIGS. 3 and 4, the water filter 3, 3a can be fastened to the ring 9, 9a with the help of a retaining nut 16. The water filter 3, 3a can be made up of different kinds of materials such as a ceramic biofilter in the case of FIG. 1 or carbon or charcoal filter in the case of FIG. 2, which have varying capabilities for filtering chemical and/or biological impurities, based on the needs. The water filter 3, 3a is also designed such that it allows for the movement of air in a direction opposite to the movement of water, which further enables a smooth and uninterrupted flow of water from the first receptacle 2, 2a to the second receptacle 6, 6a without the creation of an air lock.

The preferred embodiment further includes a container 8, 8a carrying a charge 12, 12a of beverage brewing material disposed in the second receptacle 6, 6a. For example, the container 8, 8a carrying the charge 12, 12a of beverage brewing material can be a small porous bag, a perforated metal ball or the like. The container 8, 8a can be permanently attached to the second receptacle 6, 6a or can be a disposable container 8, 8a meant for one time use. In one preferred embodiment of the invention, the container 8, 8a can be permanently attached to the second receptacle and can be opened from above to add the charge of beverage brewing material or to remove the charge after brewing. In another preferred embodiment of the invention, the container 8, 8a can be temporarily detachable from the second receptacle to add the beverage brewing material or to remove the beverage material after brewing. In another preferred embodiment of the invention, the container 8, 8a is disposable and can be shaped as a cube which allows for maximum exposure from water to coffee grounds by the design due to the high surface area to volume ratio while maintaining compactness structure to help fit inside the second receptacle.

In the preferred embodiment, the user fills the first receptacle 2, 2a with unfiltered water. The user then places the container 8, 8a carrying the charge 12, 12a of beverage brewing material in the second receptacle. The user then attaches the fitter 3, 3a to the second receptacle 6, 6a using the ring coupling 9, 9a and the retaining nut 16. After this, the user attaches the ring coupling 9, 9a to the first receptacle 2, 2a. This assembly of the combined receptacle 2, 2a and coupling 9, 9a is then held or placed such that the first receptacle 2, 2a is positioned above the second receptacle 6, 6a. The second receptacle 6, 6a is then attached to the ring coupling 9, 9a. The steps of this method can be performed in any order as long as the final assembled apparatus is the same.

The apparatus functions such that the contaminated water 1 or unfiltered water 1a moves from the first receptacle 2, 2a through the purification filter 3, 3a into the second receptacle 6, 6a and comes in contact with the container 8, 8a carrying the charge 12, 12a of beverage brewing materials allowing the beverage brewing material to steep in the filtered water 14, 14a.

The preferred embodiment also includes a timer 4, 4a capable of indicating to the user when the beverage is ready for consumption. For example, the timer 4, 4a can display a progressive bar indicating the percentage of the filtering and the brewing process that has been completed at the time. The timer can also be fashioned such that there are LED lights indicating when the process has been completed. The timer can also indicate the number of minutes remaining before the beverage is ready for consumption. Alternatively, the timer may be mechanical or a simple hour glass.

The preferred embodiment also includes a flashlight 5, 5a that provides a multipurpose use for the consumer during hiking, camping or power outages in the home. The user can use it for locating items when he or she is outdoors during hiking, camping during nighttime. The user can also use it for locating items indoor when there is a power outage.

Furthermore, as shown in the FIG. 1, in one embodiment of the invention, the first and the second receptacles 2,6 are conveniently sized to be carried by hikers, backpackers and the like and the water purification filter is made up of ceramic biofilter material.

And in another embodiment of the invention, as per FIG. 2, the first and the second receptacles 2a, 6a are conveniently sized to hold multiple servings of liquid and the water purification filter is made up of carbon or charcoal material which is effective for filtering tap water available in homes or offices, but which may not be able to filter out single celled microorganisms.

In summary, the illustrated embodiments of the invention include an integrated water filter and cold brew beverage maker using a charge of beverage brewing material. The integrated filter and maker comprise a first receptacle; a second receptacle, the second receptacle positioned below the first receptacle; a gravity fed water filter; a coupling, the first and second receptacles joined together by the coupling; and a container including the charge of beverage brewing material disposed in the second receptacle. The unfiltered water moves from the first receptacle through the water filter into the second receptacle and comes in contact with the container including the charge of beverage brewing material so that the beverage brewing material steeps in the filtered water at an ambient temperature.

The first and the second receptacles are conveniently sized to be carried by a user and the water filter is comprised of a ceramic biofilter or of a carbon or charcoal filter.

In one embodiment container including the charge of beverage brewing material has a cubic shape.

The apparatus further includes a flashlight for general use and/or a timer to indicate to a user when the beverage is ready for consumption.

The illustrated embodiments of the invention also include a method of fresh brewing a cold beverage at ambient temperature from unfiltered water comprises the steps of providing a first receptacle for holding unfiltered water, a second receptacle, a gravity-fed water filter, a coupling and a container including a charge of beverage brewing material. It is to be understood that the coupling may be a separate item or may be integrated into one or both of the receptacles. The method continues with the step of assembling the first and second receptacles so that the first receptacle is superior to the second receptacle. The first and second receptacles are joined together by the coupling with the gravity-fed water filter between them. Unfiltered water is added to the first receptacle. It is to be understood that water can also be added to the first receptacle first and then the first and second receptacles joined together. The water is allowed to move or to drop through the gravity-fed water filter into the second receptacle from the first receptacle and to steep the charge in the second receptacle to produce the fresh cold brewed beverage.

The method further includes the step of providing a timer to indicate to a user when the beverage is ready for consumption.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. An integrated water filter and cold brew beverage maker using a charge of beverage brewing material comprising:
a first receptacle;
a second receptacle, the second receptacle positioned below the first receptacle;
a gravity fed water filter;
a coupling, the first and second receptacles joined together by the coupling; and
a container including the charge of beverage brewing material disposed in the second receptacle
whereby unfiltered water moves from the first receptacle through the water filter into the second receptacle and comes in contact with the container including the charge of beverage brewing material so that the beverage brewing material steeps in the filtered water at an ambient temperature.

2. The apparatus of claim 1, in which the first and the second receptacles are conveniently sized to be carried by a user and the water filter is comprised of a ceramic biofilter.

3. The apparatus of claim 1, in which the water filter is comprised of a carbon filter.

4. The apparatus of claim 1, wherein the container including the charge of beverage brewing material is permanently attached to the second receptacle.

5. The apparatus of claim 1, wherein the container including the charge of beverage brewing material has a cubic shape.

6. The apparatus of claim 2, further comprising a flashlight.

7. The apparatus of claim 1, further comprising a timer to indicate to a user when the beverage is ready for consumption.

8. A method of fresh brewing a cold beverage from unfiltered water comprising:
providing a first receptacle for holding unfiltered water, a second receptacle, a gravity-fed water filter, a coupling and a container including a charge of beverage brewing material
assembling the first and second receptacles so that the first receptacle is superior to the second receptacle, the first and second receptacles being joined together by the coupling with the gravity-fed water filter between them;
adding unfiltered water to the first receptacle; and
allowing water to drop through the gravity-fed water filter into the second receptacle from the first receptacle and to steep the charge in the second receptacle to produce the fresh cold brewed beverage.

9. The method of claim 8 further comprising providing a timer to indicate to a user when the beverage is ready for consumption.

10. A filtered cold brew beverage maker using a charge of beverage brewing material comprising:
a first chamber;
a second chamber communicating with the first chamber; and
a filter disposed between the first and second chambers so that a charge of beverage brewing material disposed in the second chamber steeps in filtered water at an ambient temperature to produce a cold brew beverage.

11. The apparatus of claim 10 in which the first and the second chambers are conveniently sized to be carried by a user and the filter is comprised of a ceramic biofilter.

12. The apparatus of claim 10 in which the filter is comprised of a carbon filter.

13. The apparatus of claim 10 wherein the container including the charge of beverage brewing material has a cubic shape.

14. The apparatus of claim 10 wherein the container including the charge of beverage brewing material is permanently attached to the second chamber.

15. The apparatus of claim 10 further comprising a flashlight

16. The apparatus of claim 10 further comprising a timer to indicate to a user when the beverage is ready for consumption.

17. A method of fresh brewing a cold beverage from unfiltered water AT ambient temperature comprising:
providing a first chamber for holding unfiltered water, a second chamber for holding filtered water, a filter and a charge of beverage brewing material
assembling the first and second chambers together with the filter between them;
adding unfiltered water to the first chamber; and
allowing water to move through the filter into the second chamber from the first chamber and to steep the charge in the second chamber to produce the fresh cold brewed beverage at ambient temperature.

18. The method of claim 17 further comprising providing a timer to indicate to a user when the beverage is ready for consumption.
